(19) United States
(12) Patent Application Publication
(10) Pub. No.: US 2022/0066452 A1
(43) Pub. Date: Mar. 3, 2022

(54) ROUTE DETERMINATION SYSTEM, ROUTE DETERMINATION METHOD, AND ROUTE DETERMINATION PROGRAM

(71) Applicant: Toyota Jidosha Kabushiki Kaisha, Toyota-shi Aichi-ken (JP)

(72) Inventors: Kunihiro Iwamoto, Nagakute-shi Aichi-ken (JP); Yuta Itozawa, Nagoya-shi Aichi-ken (JP); Hirotaka Komura, Anjo-shi Aichi-ken (JP)

(73) Assignee: Toyota Jidosha Kabushiki Kaisha, Toyota-shi Aichi-ken (JP)

(21) Appl. No.: 17/410,240

(22) Filed: Aug. 24, 2021

(30) Foreign Application Priority Data
Aug. 26, 2020 (JP) 2020-142464

(51) Int. Cl. G05D 1/02; G01C 21/34; G01C 21/36; G05D 1/00

(52) U.S. Cl. CPC G05D 1/0212; G05D 1/0088; G01C 21/3691; G01C 21/3461

(57) ABSTRACT

A route determination system according to the present disclosure determines a transport route of an article from among a plurality of candidates. The transport route includes a first transport section for transporting the article on by a first autonomous mobile body and a second transport section for transporting the article on by a second autonomous mobile body smaller than the first autonomous mobile body. The second autonomous mobile body is mounted on the first autonomous mobile body in the first transport section. The system includes a judgement unit configured to judge whether or not weather is suitable for traveling of the second autonomous mobile body based on weather information along the transport route and a determination unit configured to determine the transport route from among the plurality of candidates so that a length of the second transport section becomes short when it is judged that the weather is not suitable.

### CROSS REFERENCE TO RELATED APPLICATIONS

This application is based upon and claims the benefit of priority from Japanese patent application No. 2020-142464, filed on Aug. 26, 2020, the disclosure of which is incorporated herein in its entirety by reference.

### BACKGROUND

The present disclosure relates to a route determination system, a route determination method, and a route determination program.

German Patent Application Publication No. 102016009572 discloses a system in which a plurality of delivery robots are mounted inside a vehicle to deliver articles. The vehicle described in German Patent Application Publication No. 102016009572 may use the plurality of delivery robots to deliver articles to a plurality of delivery destinations.

### SUMMARY

In this case, when the weather is not suitable for traveling of the delivery robot, there is a possibility that the delivery robot or the article transported by the delivery robot may be physically damaged.

The present disclosure achieves a method for determining a transport route capable of reducing a traveling distance of the delivery robot under weather unsuitable for traveling of the delivery robot.

A route determination system according to the present disclosure is for determining a transport route of an article from among a plurality of candidates,

the transport route including a first transport section for transporting the article on by the first autonomous mobile body and a second transport section for transporting the article on by the second autonomous mobile body smaller than the first autonomous mobile body, and

the second autonomous mobile body being mounted on the first autonomous mobile body in the first transport section. The route determination system includes:

a judgement unit configured to judge whether or not weather is suitable for traveling of the second autonomous mobile body based on weather information along the transport route;

a determination unit configured to determine the transport route from among the plurality of candidates so that a length of the second transport section becomes short when it is judged that the weather is not suitable for the traveling of the second autonomous mobile body.

A route determination method according to the present disclosure is for determining a transport route of an article from among a plurality of candidates,

the transport route including a first transport section for transporting the article on by the first autonomous mobile body and a second transport section for transporting the article on by the second autonomous mobile body smaller than the first autonomous mobile body, and

the second autonomous mobile body being mounted on the first autonomous mobile body in the first transport section. The route determination method includes:

judging whether or not weather is suitable for traveling of the second autonomous mobile body based on weather information along the transport route;

determining, based on the weather information along the transport route, the transport route from among the plurality of candidates so that a length of the second transport section becomes short when it is judged that the weather is not suitable for the traveling of the second autonomous mobile body.

A route determination program according to the present disclosure is for determining a transport route of an article from among a plurality of candidates,

the transport route including a first transport section for transporting the article on by the first autonomous mobile body and a second transport section for transporting the article on by the second autonomous mobile body smaller than the first autonomous mobile body, and

the second autonomous mobile body being mounted on the first autonomous mobile body in the first transport section. The route determination program causes a computer to execute:

judging whether or not weather is suitable for traveling of the second autonomous mobile body based on weather information along the transport route;

determining the transport route from among the plurality of candidates so that a length of the second transport section becomes short when it is judged that the weather is not suitable for the traveling of the second autonomous mobile body.

According to the present disclosure, it is possible to reduce a traveling distance of the delivery robot under weather unsuitable for traveling of a delivery robot.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram showing an overview of a route determination system according to a first embodiment;

FIG. 2 is a configuration diagram showing a configuration of the route determination system according to the first embodiment;

FIG. 3 is a block diagram showing a configuration of a server according to the first embodiment;

FIG. 4 is a flowchart showing an operation of the route determination system according to the first embodiment;

FIG. 5 is a schematic diagram showing an example of a delivery area;

FIG. 6 shows an example of a candidate of a transport route specified by the route determination system according to the first embodiment;

FIG. 7 is a schematic diagram showing an overview of a route determination system according to a second embodiment;

FIG. 8 is a configuration diagram showing a configuration of a server according to the second embodiment;

FIG. 9 is a schematic diagram showing candidates of a transport route specified by the route determination system according to the second embodiment; and

FIG. 10 is a schematic diagram showing a candidate of the transport route specified by the route determination system according to the second embodiment.

### DESCRIPTION OF EMBODIMENTS

### First Embodiment

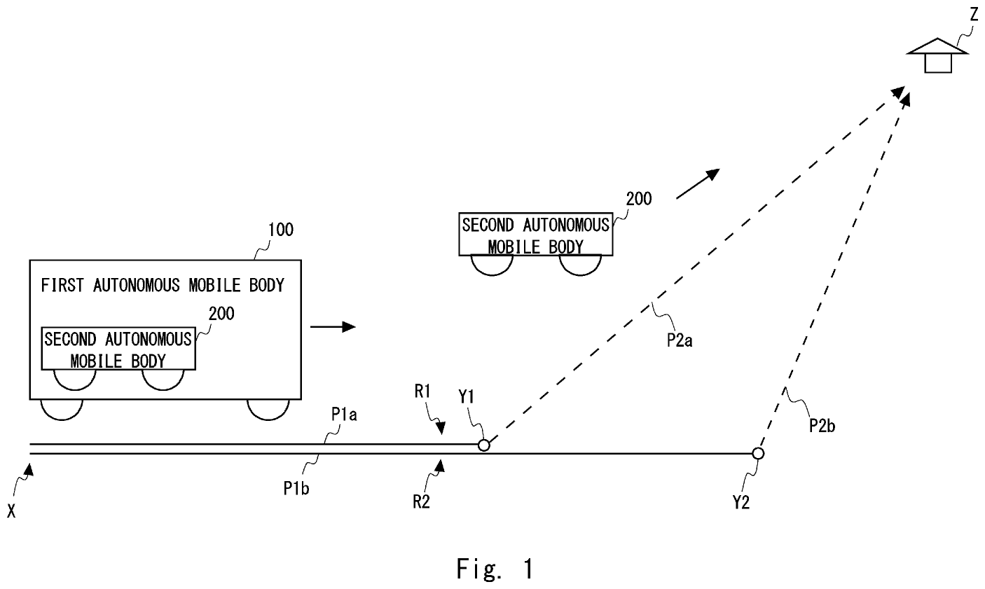

Embodiments of the present disclosure will be described below with reference to the drawings. FIG. 1 is a schematic diagram showing an overview of a route determination system 500 according to a first embodiment. The route determination system 500 determines a transport route of an article from a starting point X to a destination point Z.

Here, the transport route includes a first transport section P1 for a first autonomous mobile body 100 to transport the article and a second transport section P2 for a second autonomous mobile body 200 to transport the article. The first transport section P1 is a section from the starting point X to an intermediate point Y. The second transport section P2 is a section from the intermediate point Y to the destination point Z. At the intermediate point Y, the articles are transferred from the first autonomous mobile body 100 to the second autonomous mobile body 200. The intermediate point may be a parking lot or the like where the first autonomous mobile body 100 can stop.

FIG. 1 shows a candidate R1 of the transport route including a section P1a and a section P2a, and a candidate R2 of the transport route including a section P1b and a section P2b. The intermediate point in the candidate R1 is an intermediate point Y1, and the intermediate point in the candidate R2 is an intermediate point Y2. In the drawing, the first transport sections are indicated by solid lines, and the second transport sections are indicated by dotted lines.

The second autonomous mobile body 200 is an autonomous mobile body smaller than the first autonomous mobile body 100, and is mounted on the first autonomous mobile body 100 in the first transport section P1. For example, the second autonomous mobile body 200 is a delivery robot, and the first autonomous mobile body 100 is an automatic drive vehicle capable of traveling with the delivery robot mounted thereon. The second autonomous mobile body 200 starts transporting the article from a stop position (the intermediate point) where the first autonomous mobile body 100 stops.

When the weather along the transport route is rainy, there is a possibility that the article transported by the second autonomous mobile body 200 may get wet. When the weather along the transport route is snowy, there is a possibility that the article transported by the second autonomous mobile body 200 may be covered with snow.

The function of a sensor or the like of the second autonomous mobile body 200 may be inferior to that of the larger first autonomous mobile body 100. In such a case, the second autonomous mobile body 200 may not be able to recognize a current position of the second autonomous mobile body 200 under weather conditions such as rain or snow, and may not be able to move autonomously. The route determination system 500 determines a transport route so that a traveling distance of the second autonomous mobile body becomes short under weather conditions such as rain and snow unsuitable for traveling of the second autonomous mobile body 200.

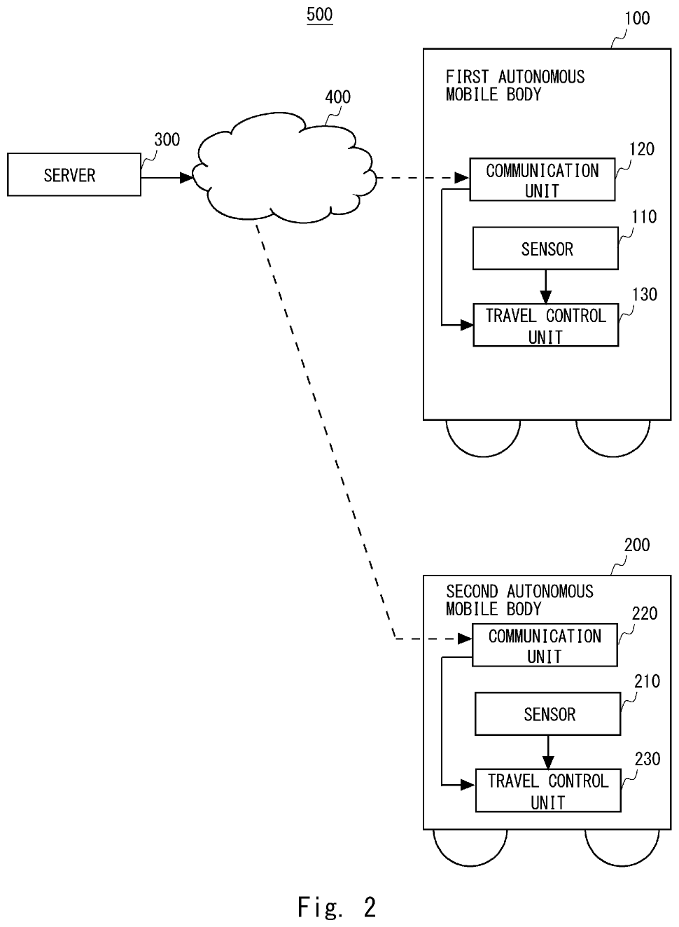

Next, a configuration of the route determination system 500 will be described with reference to FIG. 2. The route determination system 500 includes the first autonomous mobile body 100, the second autonomous mobile body 200, and a server 300. The first autonomous mobile body 100, the second autonomous mobile body 200, and the server 300 are connected to each other via a network 400. The network 400 is a communication line network such as the Internet, an intranet, a cellular phone network, and a LAN (Local Area Network).

The server 300 determines the transport route of the article. The server 300 transmits, to the first autonomous mobile body 100, a part of the determined transport route corresponding to the first transport section P1, and transmits a part of the determined transport route corresponding to the second transport section P2 to the second autonomous mobile body 200.

The first autonomous mobile body 100 includes a sensor 110, a communication unit 120, and a travel control unit 130. The sensor 110 collects environmental data around the first autonomous mobile body 100 and outputs it to the travel control unit 130. The sensor 110 is, for example, a camera, radar, LIDAR, or the like. The communication unit 120 is a communication interface for performing wireless communication with the network 400. The communication unit 120 receives the transport route determined by the server 300 via the network 400.

The travel control unit 130 controls the first autonomous mobile body 100 to autonomously move along the transport route using the environmental data collected by the sensor 110. Here, it is assumed that the first autonomous mobile body 100 acquires the position of the autonomous mobile body 100 by GPS (Global Positioning System), the sensor 110, or the like.

The second autonomous mobile body includes a sensor 210, a communication unit 220, and a travel control unit 230. The sensor 210 has the same function as that of the sensor 110, the communication unit 220 has the same function as that of the communication unit 120, and the travel control unit 230 has the same function as that of the travel control unit 130.

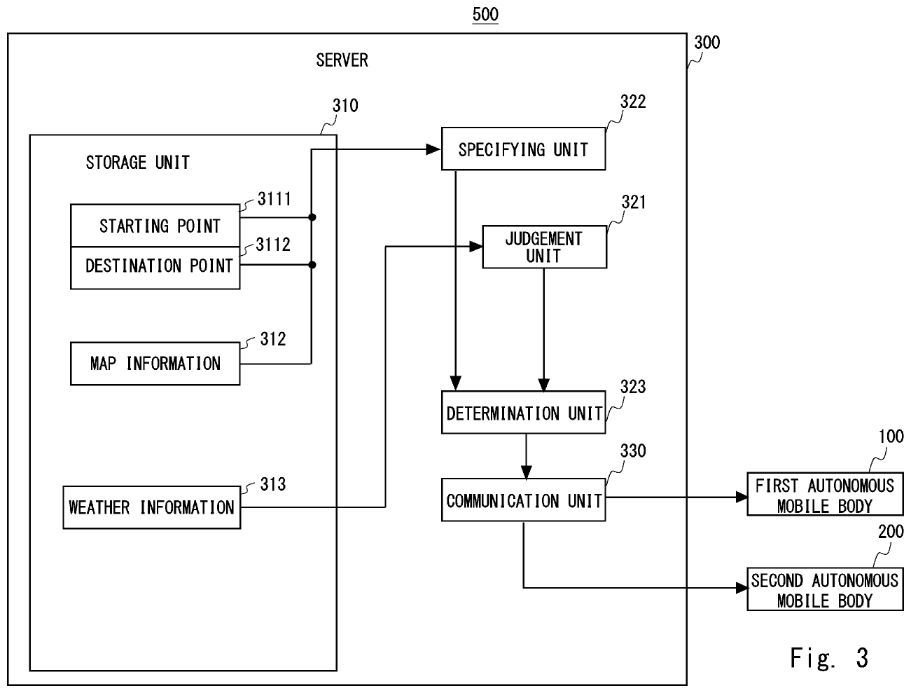

Next, the server 300 will be described in detail with reference to FIG. 3. The server 300 determines the transport route for transporting the article on by the first autonomous mobile body 100 and the second autonomous mobile body 200. The server 300 includes a storage unit 310, a judgement unit 321, a specifying unit 322, a determination unit 323, and a communication unit 330.

The storage unit 310 is a storage apparatus such as a hard disk or a flash memory. The storage unit 310 may also include a volatile storage apparatus such as a RAM (Random Access Memory) which is a storage area for temporarily holding information. The communication unit 330 is a communication interface with the network 400.

The storage unit 310 stores a starting point 3111, a destination point 3112, and map information 312. The storage unit 310 stores the starting point 3111 and the destination point 3112 when the article is transported in association with each other.

The map information 312 is map data including a delivery area. The specifying unit 322, which will be described later, specifies a plurality of candidates of the transport route using the map information 312. The map information 312 may be, for example, data of a road map in which nodes representing intersections and links representing passages are numbered. The map information 312 may be an environmental map showing an area of a building as an obstacle or the like. The map information 312 may include information about a width of the passage. In such a case, the specifying unit 322 described later can specify an appropriate candidate of the transport route based on the sizes of the first autonomous mobile body 100 and the second autonomous mobile body.

Weather information 313 is information representing weather along the transport route. The weather information 313 may be information indicating weather such as sunny, cloudy, rainy, or the like, or information indicating an amount of rainfall, an amount of snow, and a wind speed. The weather information 313 may include the density of yellow sand and the like.

The judgement unit 321 judges whether or not the weather is suitable for traveling of the second autonomous mobile body 200 based on the weather information 313. The judgement unit 321 may judge whether the weather is suitable for the traveling of the second autonomous mobile body 200 based on at least one of the amount of rainfall, the amount of snow, and the wind speed. For example, the judgement unit 321 may judge that the weather is not suitable for the traveling of the second autonomous mobile body 200 when the amount of rainfall exceeds a predetermined threshold. Note that the judgement unit 321 may acquire weather information along the transport route from the weather information collected at various places on the Internet or the like, and judge whether or not the weather is suitable for the traveling of the second autonomous mobile body 200.

The specifying unit 322 specifies a plurality of candidates for the transport route from the starting point 3111 to the destination point 3112 using the map information 312. The specifying unit 322 selects, for example, a plurality of intermediate points Y at which the first autonomous mobile body can stop around the destination point 3112. Then, the specifying unit 322 may specify, for each of the plurality of intermediate points Y, the first transport section from the starting point 3111 to the intermediate point Y and the second transport section from the intermediate point Y to the destination point 3112 to thereby specify the plurality of candidates. Note that the specifying unit 322 may specify the plurality of candidates having a common intermediate point Y and different second transport sections.

When it is judged by the judgement unit 321 that the weather is not suitable for the traveling of the second autonomous mobile body 200, the determination unit 323 determines the transport route from among the plurality of candidates so that the length of the second transport section becomes short. For example, the determination unit 323 may determine the candidate having the shortest second transport section from among the plurality of candidates as the transport route. Further, the determination unit 323 may determine, as the transport route, a candidate having the second or third shortest length of the second transport section from among the plurality of candidates. The length of the second transport section may be calculated by the determination unit 323 or the specifying unit 322.

Note that the functions of the judgement unit 321, the specifying unit 322, and the determination unit 323 may be implemented by a processor (not shown) reading a program into a RAM and executing the program.

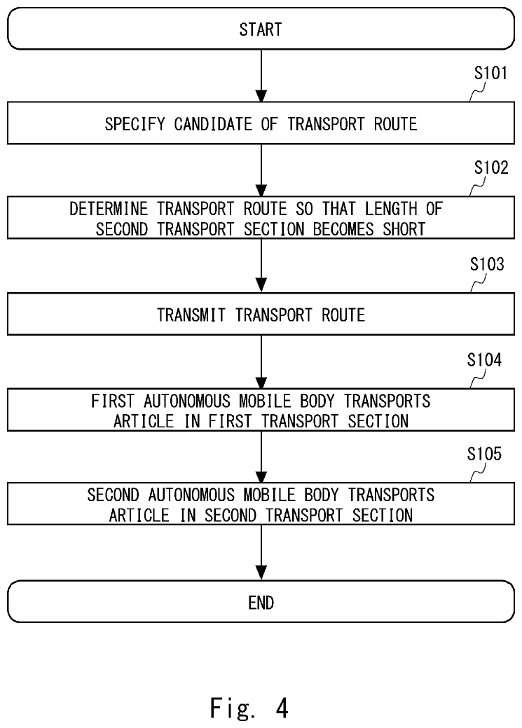

FIG. 4 is a flowchart showing the operation of the route determination system 500 according to the first embodiment. It is assumed that the judgement unit 321 judges that the weather is not suitable for the traveling of the second autonomous mobile body 200.

First, the route determination system 500 specifies the plurality of candidates of the transport route from the starting point 3111 to the destination point 3112 (Step S101). Here, the route determination system 500 may specify an appropriate candidate so that the transport route does not become too long. The starting point 3111 may be a warehouse for storing delivery articles. The destination point 3112 is information indicating a delivery destination of the article.

Next, the determination unit 323 determines the transport route from among the plurality of candidates specified in Step S101 so that the length of the second transport section becomes short (Step S102). Next, the server 300 transmits the determined transport route to the first autonomous mobile body 100 and the second autonomous mobile body 200 (Step S103). Next, the first autonomous mobile body 100 autonomously moves in the first transport section along the transport route received in Step S103 (Step S104). Finally, the second autonomous mobile body 200 autonomously moves in the second transport section along the transport route received in Step S103, and transports the article to the destination point 3112 (Step S105).

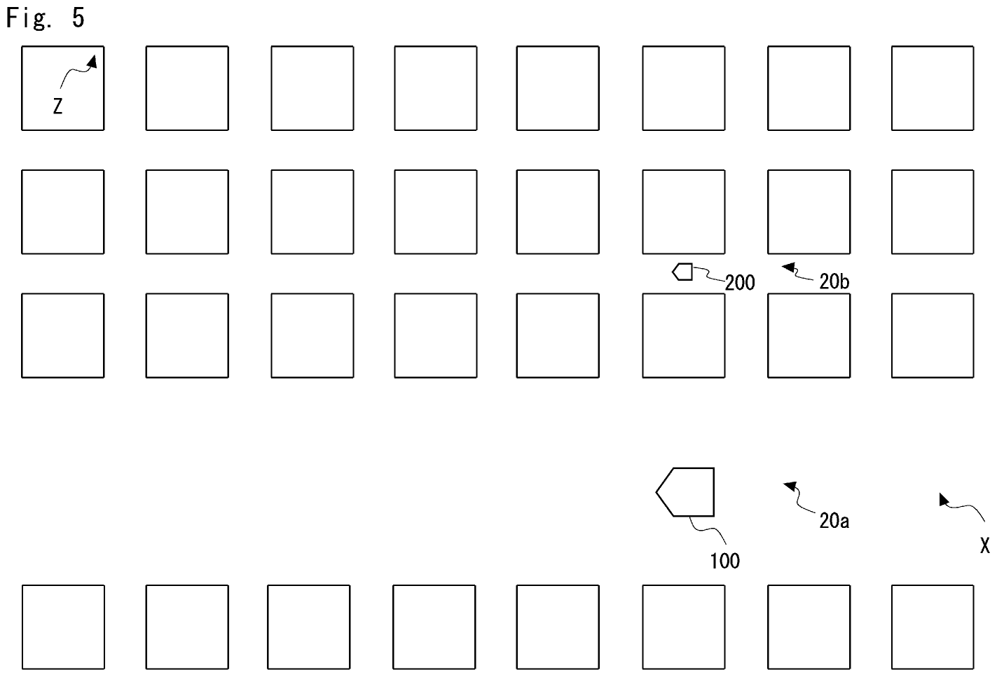

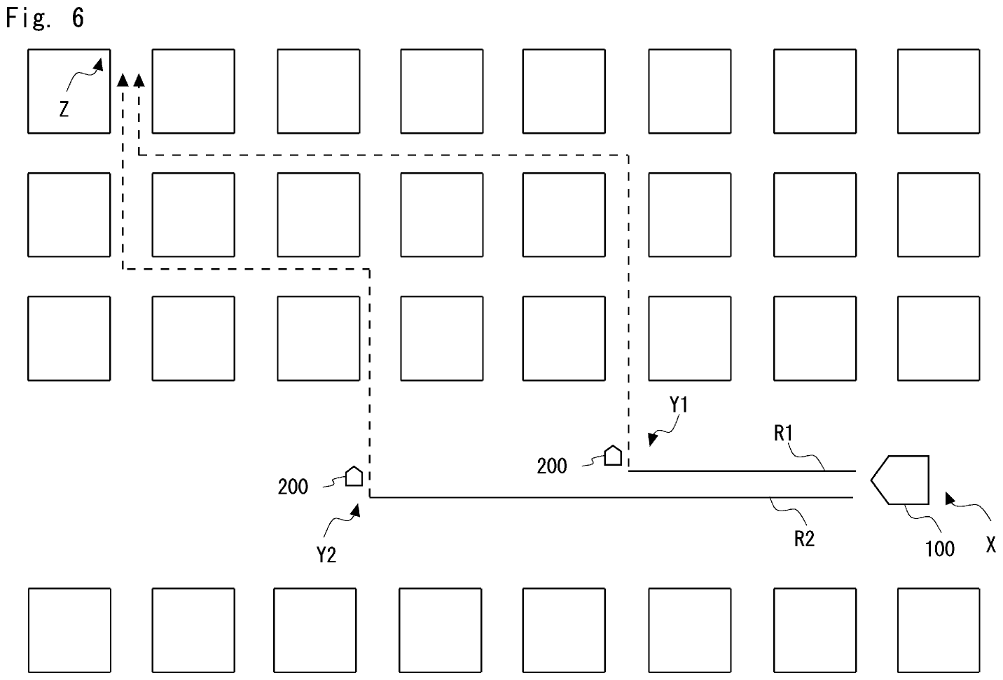

Next, a specific example of the candidate of the transport route will be described with reference to FIGS. 5 and 6. FIG. 5 is a map showing the delivery area. The route determination system 500 shall determine the transport route from a point X to a point Z.

It is assumed that the route determination system 500 judges that the weather along the transport route is not suitable for the traveling of the second autonomous mobile body 200. The delivery area includes two types of passages with different widths. The first autonomous mobile body 100 can pass through the passages 20a but cannot pass through the passages 20b. The second autonomous mobile body 200 can pass through the passages 20a and the passage 20b.

The specifying unit 322 specifies the plurality of candidates of the transport route. FIG. 6 shows the plurality of candidates R1 and R2 specified by the specifying unit 322. The intermediate points Y1 and Y2 are positions where the first autonomous mobile body 100 can stop. The route determination system 500 specifies the first transport section from the starting point X to the intermediate point Y1 and the second transport section from the intermediate point Y1 to the destination point Z, and designates the transport route as the candidate R1. Further, the route determination system 500 specifies the first transport section from the starting point X to the intermediate point Y2 and the second transport section from the intermediate point Y2 to the destination point Z, and designates the transport route as the candidate R2. In the drawing, the first transport sections are indicated by solid lines, and the second transport sections are indicated by dotted lines.

The determination unit 323 compares the length of the second transport section in the candidate R1 with the length of the second transport section in the candidate R2. The determination unit 323 determines the candidate R2 having a second transport section shorter than that in the case of the candidate R1 as the transport route.

The second transport section in the transport route may include a route from the stop position of the first autonomous mobile body 100 to the delivery destination of the article and a route from the delivery destination to the stop position. That is, when the second autonomous mobile body 200 returns to the stop position of the first autonomous mobile body 100 after the article is delivered, the transport route may include a travel path from the destination point Z to the intermediate point Y.

Further, the specifying unit 322 may specify the candidate in which the first autonomous mobile body 100 stops on the passage in front of the delivery destination. If there is such a candidate, the route determination system 500 determines the candidate as the transport route. The second autonomous mobile body 200 transports the package within the site of the delivery destination.

When it is judged that the weather is not suitable for the traveling of the second autonomous mobile body 200, the route determination system 500 determines the transport route so that the distance traveled by the second autonomous mobile body becomes short. Thus, the route determination system 500 can reduce the distance traveled by the second autonomous mobile body under the weather unsuitable for the traveling of the second autonomous mobile body.

Although the case where the server 300 determines the transport route has been described, the first autonomous mobile body 100 may acquire the information of the delivery destination and determine the transport route from the current position to the delivery destination. That is, the processing performed by the judgement unit 321, the specifying unit 322, and the determination unit 323 may be performed on the first autonomous mobile body 100 side. The first autonomous mobile body 100 autonomously moves in the first transport section along the transport route determined by the first autonomous mobile body 100 itself to deliver the article. Then, the first autonomous mobile body 100 transmits a part of the transport route corresponding to the second transport section to the second autonomous mobile body 200. In such a case, the route determination system 500 may not include the server 300. That is, a system in which the processing is completed in the first autonomous mobile body 100 and the second autonomous mobile body 200 can also be included in the route determination system 500 according to the first embodiment.

### Second Embodiment

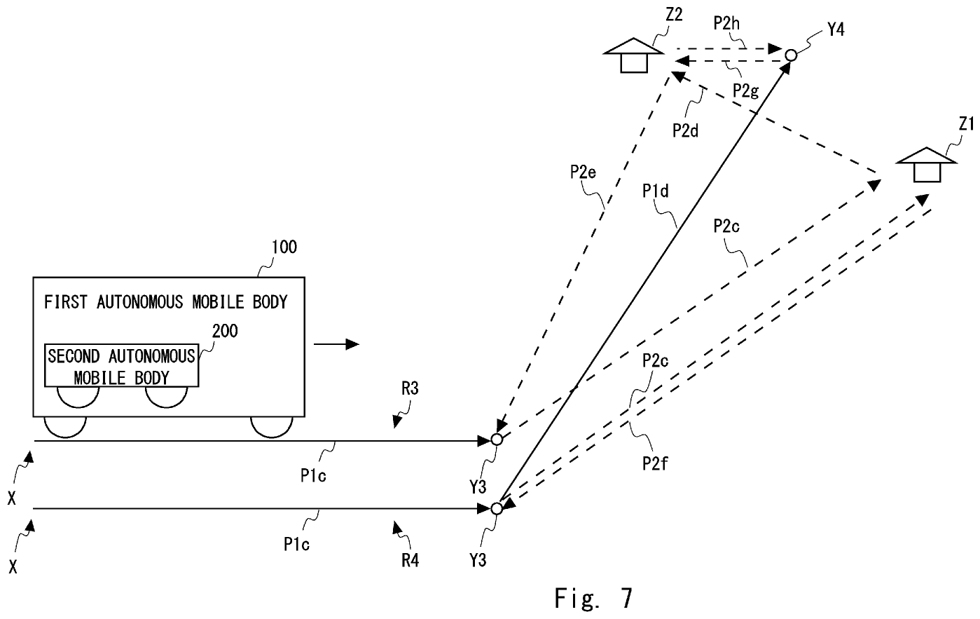

FIG. 7 is a schematic diagram showing an overview of the route determination system 500a according to the second embodiment. The route determination system 500a determines, for each of the plurality of delivery destinations, a route for delivering an article corresponding to the delivery destination. The route determination system 500a determines, for example, a transport route for transporting the article from a starting point X to a destination point Z1 and a destination point Z2.

In FIG. 7, there are a candidate R3 including one first transport section and a candidate R4 including two first transport sections. Note that the starting points X of the candidate R3 and the candidate R4 are the same position, but are shown as different positions in the drawing in order to facilitate the explanation. Likewise, a section P1c of the candidate R3 and the section P1c of the candidate R4 are the same route, but are shown at distant positions in order to facilitate the explanation. The same applies to an intermediate point Y3 and a section P2c.

The candidate R3 includes the section P1c in which the first autonomous mobile body 100 moves from the starting point X to the intermediate point Y3, the section P2c in which the second autonomous mobile body 200 moves from the intermediate point Y3 to the destination point Z1, a section P2d in which the second autonomous mobile body 200 moves from the destination point Z1 to the destination point Z2, and a section P2e in which the second autonomous mobile body 200 moves from the destination point Z2 to the destination point Y3.

On the other hand, the candidate R4 includes the section P1c in which the first autonomous mobile body 100 moves from the starting point X to the intermediate point Y3, the section P2c in which the second autonomous mobile body 200 moves from the intermediate point Y3 to the destination point Z1, and a section P2f in which the second autonomous mobile body 200 returns from the destination point Z1 to the intermediate point Y3. The candidate R4 includes a section P1d in which the first autonomous mobile body 100 moves from the intermediate point Y3 to an intermediate point Y4, the section P2g in which the second autonomous mobile body 200 moves from the intermediate point Y4 to the destination point Z2, and a section P2h in which the second autonomous mobile body 200 moves from the destination point Z2 to the intermediate point Y4. In the drawing, the first transport sections are indicated by solid lines, and the second transport sections are indicated by dotted lines.

As described above, when there are a plurality of delivery destinations, there may be a plurality of candidates of the transport route in which the number of times of movement of the first autonomous mobile body 100 differs from each other. Even in such a case, the route determination system 500a determines the transport route so that the traveling distance of the second autonomous mobile body 200 under the weather unsuitable for traveling becomes short.

The configuration of the route determination system 500a is similar to that of FIG. 2, and includes a server 300a, the first autonomous mobile body 100, and the second autonomous mobile body 200. Since the functions of the first autonomous mobile body 100 and the second autonomous mobile body 200 are the same as those according to the first embodiment, the description thereof will be omitted.

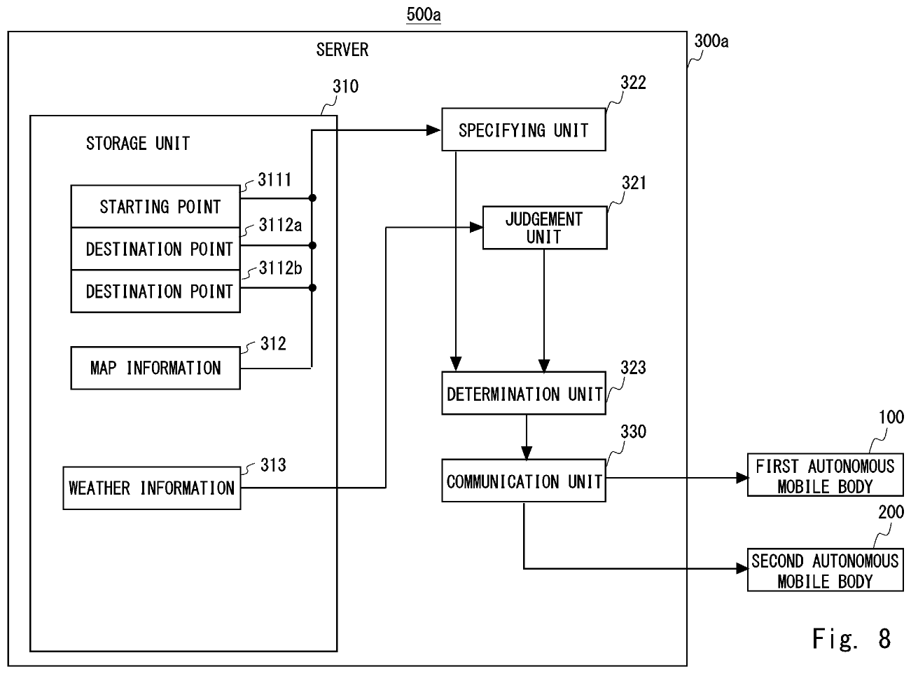

Next, the server 300a will be described in detail with reference to FIG. 8. Hereinafter, a difference between the second embodiment and the first embodiment will be mainly described. The storage unit 310 of the server 300a stores a plurality of destination points 3112a and 3112b. The storage unit 310 may store three or more destination points.

The specifying unit 322 uses the map information 312 to specify candidates of the transport route which depart from the starting point 3111 and pass through the destination points 3112a and 3112b. The specifying unit 322 outputs the plurality of specified candidates to the determination unit 323. In a manner similar to the first embodiment, the transport route may include a route in which the second autonomous mobile body 200 returns to the stop position of the first autonomous mobile body 100. That is, the second transport section may include a route from the stop position of the first autonomous mobile body 100 to any one of the plurality of delivery destinations and a route from any one of the plurality of delivery destinations to the stop position.

The specifying unit 322 selects, for example, the intermediate point Y around the destination point 3112a and the destination point 3112b where the first autonomous mobile body 100 can stop, and specifies the first transport section from the starting point 3111 to the intermediate point Y. The specifying unit 322 may specify the second transport section in which the second autonomous mobile body 200 departs from the intermediate point Y and visits the destination points 3112a and 3112b. The specifying unit 322 may also specify the candidate of the transport route in which the first autonomous mobile body 100 stops around the destination point 3112a and further stops around the destination point 3112b.

In a manner similar to the first embodiment, when the weather along the transport route is not suitable for the traveling of the second autonomous mobile body 200, the determination unit 323 determines the transport route from among the plurality of candidates specified by the specifying unit 322 so that the length of the second transport section becomes short. The determination unit 323 transmits a part corresponding to the first transport section to the first autonomous mobile body 100 and a part corresponding to the second transport section to the second autonomous mobile body 200 via the communication unit 330. When the weather is suitable for the traveling of the second autonomous mobile body 200, the determination unit 323 may decide, as the transport route, the candidate having a small stopping frequency of the first autonomous mobile body 100 or the candidate having a short transport time.

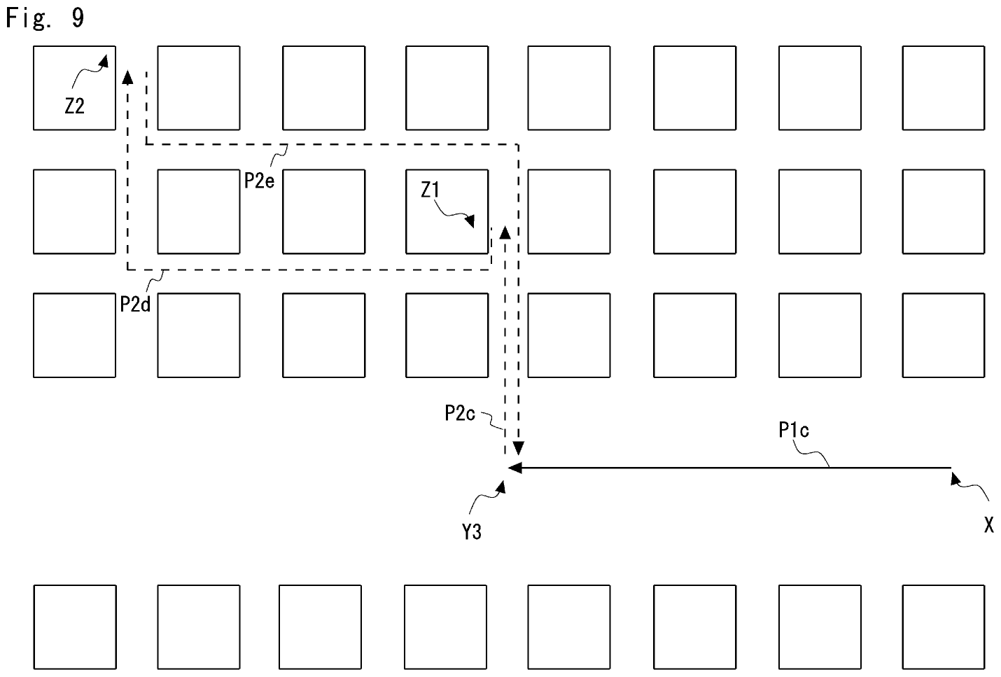

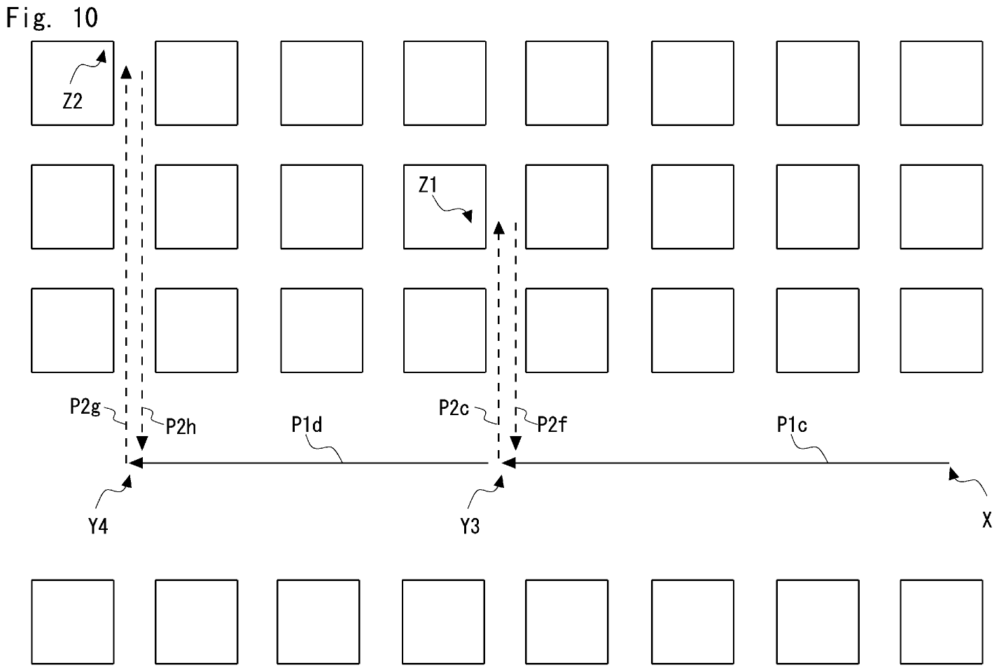

A specific example of the transport route will be described with reference to FIGS. 9 and 10. The route determination system 500a shall determine the transport route for transporting the articles from the starting point X to the destination points Z11 and Z2. FIG. 9 shows a candidate of the transport route when the first autonomous mobile body 100 stops at one intermediate point Y3. FIG. 10 shows a candidate of the transport route when the first autonomous mobile body 100 stops at two intermediate points Y3 and Y4. The case where the transport route includes a part where the second autonomous mobile body 200 returns to the stop position (the intermediate point) of the first autonomous mobile body 100 will be described.

The second transport section in the candidate shown in FIG. 9 is the section P2c from the intermediate point Y3 to the destination point Z1, the section P2d from the destination point Z1 to the destination point Z2, and the section P2e from the destination point Z2 to the intermediate point Y3. Note that the section P1c is the first transport section.

The second transport section in the candidate shown in FIG. 10 is the section P2c from the intermediate point Y3 to the destination point Z1, the section P2f from the destination point Z1 to the intermediate point Y3, the section P2g from the intermediate point Y4 to the destination point Z2, and the section P2h from the destination point Z2 to the intermediate point Y4. Note that the sections P1c and P1d are the first transport sections.

For example, when the length of the second transport section in the candidate shown in FIG. 9 is 400 m and the length of the second transport section in the candidate shown in FIG. 10 is 300 m, the determination unit 323 determines the candidate shown in FIG. 10 as the transport route.

As described above, even when the transport route includes the plurality of delivery destinations, in a manner similar to the first embodiment, the transport route can be determined so that the second autonomous mobile body travels a short distance under the weather unsuitable for the traveling of the second autonomous mobile body.

Although the above embodiments have been described as a hardware configuration, the present disclosure is not limited thereto. The present disclosure may be realized by causing a CPU to execute a computer program for executing specified processing.

In the above example, the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the embodiments described above, and may be appropriately modified without departing from the spirit thereof.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A route determination system for determining a transport route of an article from among a plurality of candidates,
the transport route including a first transport section for transporting the article on by a first autonomous mobile body and a second transport section for transporting the article on by a second autonomous mobile body smaller than the first autonomous mobile body, and
the second autonomous mobile body being mounted on the first autonomous mobile body in the first transport section, the route determination system comprising:
a judgement unit configured to judge whether or not weather is suitable for traveling of the second autonomous mobile body based on weather information along the transport route; and
a determination unit configured to determine the transport route from among the plurality of candidates so that a length of the second transport section becomes short when it is judged that the weather is not suitable for the traveling of the second autonomous mobile body.

2. The route determination system according to claim 1, wherein
the transport route is a route for delivering the article corresponding a delivery destination for each of a plurality of the delivery destinations, and
the second transport section includes a path from a stop position of the first autonomous mobile body to any one of the plurality of delivery destinations, and a path from the one of the plurality of delivery destinations to the stop position.

3. The route determination system according to claim 1, wherein
the judgement unit is configured to judge whether or not the weather is suitable for the traveling of the second autonomous mobile body based on at least one of an amount of rainfall, an amount of snow, and a wind speed.

4. The route determination system according to claim 1, wherein
the judgement unit is configured to acquire the weather information along the transport route from the weather information in each place.

5. A route determination method for determining a transport route of an article from among a plurality of candidates,
the transport route including a first transport section for transporting the article on by a first autonomous mobile body and a second transport section for transporting the article on by a second autonomous mobile body smaller than the first autonomous mobile body, and
the second autonomous mobile body being mounted on the first autonomous mobile body in the first transport section, the route determination method comprising:
judging whether or not weather is suitable for traveling of the second autonomous mobile body based on weather information along the transport route;
determining, based on the weather information along the transport route, the transport route from among the plurality of candidates so that a length of the second transport section becomes short when it is judged that the weather is not suitable for the traveling of the second autonomous mobile body.

6. A non-transitory computer readable medium storing a route determination program for determining a transport route of an article from among a plurality of candidates,
the transport route including a first transport section for transporting the article on by a first autonomous mobile body and a second transport section for transporting the article on by a second autonomous mobile body smaller than the first autonomous mobile body, and
the second autonomous mobile body being mounted on the first autonomous mobile body in the first transport section, the route determination program causing a computer to execute:
judging whether or not weather is suitable for traveling of the second autonomous mobile body based on weather information along the transport route;
determining the transport route from among the plurality of candidates so that a length of the second transport section becomes short when it is judged that the weather is not suitable for the traveling of the second autonomous mobile body.
